(19) United States
(12) Patent Application Publication
(10) Pub. No.: US 2002/0121002 A1
(43) Pub. Date: Sep. 5, 2002

(54) STRUCTURE OF HINGE FOR USE IN A COMPUTER

(76) Inventor: Yu-Chih Wu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/796,512

(22) Filed: Mar. 2, 2001

(51) Int. Cl. E05D 11/08

(52) U.S. Cl. 16/342

(57) ABSTRACT

A hinge includes a shaft member and a pivot holder coupled together respectively fastened to two movable parts of a computer apparatus for enabling the movable parts to be turned relative to each other, the shaft member having a headed pivot rod mounted with a bushing, two rubber rings, a copper ring and a metal reinforcing ring, the pivot holder having a socket fastened to the bushing to protect the rubber rings against outside moisture, the rubber rings being squeezed against the shaft member to stop the shaft member from rotary motion relative to the pivot holder.

### BACKGROUND OF THE INVENTION

The present invention relates to a hinge for use in a computer apparatus and, more particularly, to such a hinge that can easily be turned to the desired angle and then positively positioned in the adjusted angle.

In a mobile computer, for example, a notebook computer, hinge means is used to couple two movable parts (the mainframe and the LCD module) of the notebook computer, for enabling the movable parts to be turned relative to each other between the close position and the open position. FIGS. 1A and 1B show a hinge for this purpose. This structure of hinge comprises a mounting frame 40, a pivot shaft 42, a positioning unit W, and two washers 44. The mounting frame 40 is fixedly fastened to, for example, the mainframe of the notebook computer, comprising a coupling plate 41 and a pivot hole 410 at one end of the coupling plate 41. The pivot shaft 42 comprises a flat rear mounting tail 421 fixedly fastened to, for example, the LCD module of the notebook computer, a threaded shaft body 420 inserted through the pivot hole 410, and a collar 422 disposed between the flat rear mounting tail 421 and the threaded shaft body 420 and stopped at one end of the pivot hole 410. The positioning unit W is fastened to the threaded shaft body 420 of the pivot shaft 42 to secure the pivot shaft 42 to the mounting frame 40, enabling the pivot shaft 42 to be turned relative to the mounting frame 40 and positioned in the desired angle. The positioning unit W comprises two leftwards protruded convex spring plates 46 and 47 mounted on the threaded shaft body 420 of the pivot shaft 42 and attached together, two rightwards protruded convex spring plates 48 and 49 mounted on the threaded shaft body 420 of the pivot shaft 42 and attached together and stopped against the leftwards protruded convex spring plates 46 and 47, a nut 43 threaded onto the threaded shaft body 420 to secure the leftwards protruded convex spring plates 46 and 47 and the rightwards protruded convex spring plates 48 and 49 to the pivot shaft 42, and a flat friction plate 45 mounted on the threaded shaft body 420 of the pivot shaft 42 and stopped between the nut 43 and the rightwards protruded convex spring plate 48. This structure of hinge is still not satisfactory in function. The drawbacks of this structure of hinge are numerous and outlined hereinafter.

1. The positioning force is obtained from the contact areas L around the inner diameter and outer diameter of the convex spring plates 46, 47, 48 and 49. Because the contact areas L are of line contact, the convex spring plates 46, 47, 48 and 49 must have high spring power so as to support the pivot shaft 42 in position when squeezed to deform.

2. Because all the component parts of the hinge are made of metal, less positioning force is produced between each two metal component parts. According to test, the coefficient of friction between each two metal members is less than the coefficient of friction between one metal member and one plastic member.

3. Because the spring power of the convex spring plates 46, 47, 48 and 49 deteriorates with use, the nut 43 must be fastened tight regularly.

4. Frequently opening/closing the two movable parts (the mainframe and the LCD module) of the device (the notebook computer) in which the hinge is installed may cause the nut to loosen, resulting in a positioning failure.

5. The threads of the threaded shaft body 420 of the pivot shaft 42 wear quickly with use because these convex spring plates 46, 47, 48 and 49 are forced to rub against the threads of the threaded shaft body 420 of the pivot shaft 42 when opening/closing the two movable parts (the mainframe and the LCD module) of the device (the notebook computer) in which the hinge is installed.

6. Because the positioning unit W requires much installation space, the dimension of the hinge cannot be minimized as desired.

7. Because the hinge is comprised of a big number of parts, the structure of the hinge and its maintenance work are complicated.

8. Further, the component parts of the hinge provide less spring power and tend to be covered with dust because they are not enclosed (if the convex spring plates 46, 47, 48 and 49 are enclosed, much reactive force can be produced to provide relatively higher spring power).

### SUMMARY OF THE INVENTION

The present invention has been accomplished to provide a hinge, which eliminates the aforesaid drawbacks. It is one object of the present invention to provide a hinge, which has a simple structure. It is another object of the present invention to provide a hinge, which is durable in use. It is still another object of the present invention to provide a hinge, which requires less installation space. It is still another object of the present invention to provide a hinge, which can be conveniently rotated to the desired angle and then positively positioned in the adjusted angle without causing deadlocking. According to one aspect of the present invention, the hinge comprises shaft member and a pivot holder coupled together respectively fastened to two movable parts of a computer apparatus for enabling the movable parts to be turned relative to each other, the shaft member having a headed pivot rod mounted with a bushing, two rubber rings, a copper ring and a metal reinforcing ring, the pivot holder having a socket fastened to the bushing to protect the rubber rings against outside moisture, the rubber rings being squeezed against the shaft member to stop the shaft member from rotary motion relative to the pivot holder. According to another aspect of the present invention, the component parts that are mounted on the pivot rod of the shaft member are well protected inside the socket of the pivot holder. According to still another aspect of the present invention, the bushing has two tapered chambers at two sides thereof, each tapered chamber having a diameter made gradually smaller toward the inside of the bushing for positive positioning of the rubber rings. According to still another aspect of the present invention, the copper ring is supported between the metal reinforcing ring and one rubber ring in one tapered chamber of the bushing for enabling the shaft member to be rotated by force relative to the pivot holder without causing a dead locking. According to still another aspect of the present invention, the front peripheral edge of the socket is hammered down and secured to a sloping peripheral edge of the bushing and the end of the pivot rod is hammered down to form the pivot head to stop the bushing, the rubber rings, the copper ring and the metal reinforcing ring in place, and therefore the parts of the hinge are prohibited from falling out.

### BRIEF DESCRIPTION OF THE DRAWINGS

FIG. 1A is an exploded view of a hinge according to the prior art.

FIG. 1B is a sectional assembly view of the hinge according to the prior art.

FIG. 2 is an exploded view of a hinge according to the present invention.

FIG. 2A is a sectional view in an enlarged scale of a part of FIG. 2.

FIG. 3A is a sectional assembly view of the present invention.

FIG. 3B is an enlarged view of a part of FIG. 3A.

FIG. 3C is an enlarged view of another part of FIG. 3A.

FIG. 3D is an installed view of the present invention.

FIG. 4A is a front view in section in an enlarged scale of a part of the hinge according to the present invention.

FIG. 4B is a side view in section in an enlarged scale of the hinge according to the present invention.

FIG. 5A is an exploded view in section of an alternate form of the hinge according to the present invention.

FIG. 5B is a sectional assembly view of the alternate form of the hinge shown in FIG. 5A.

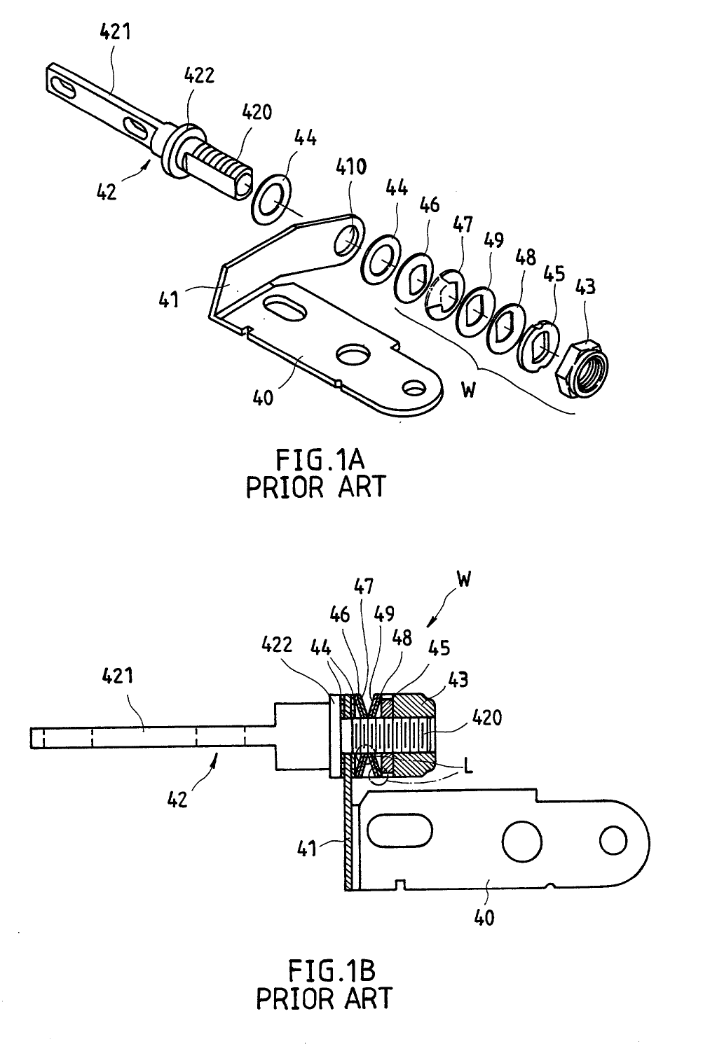

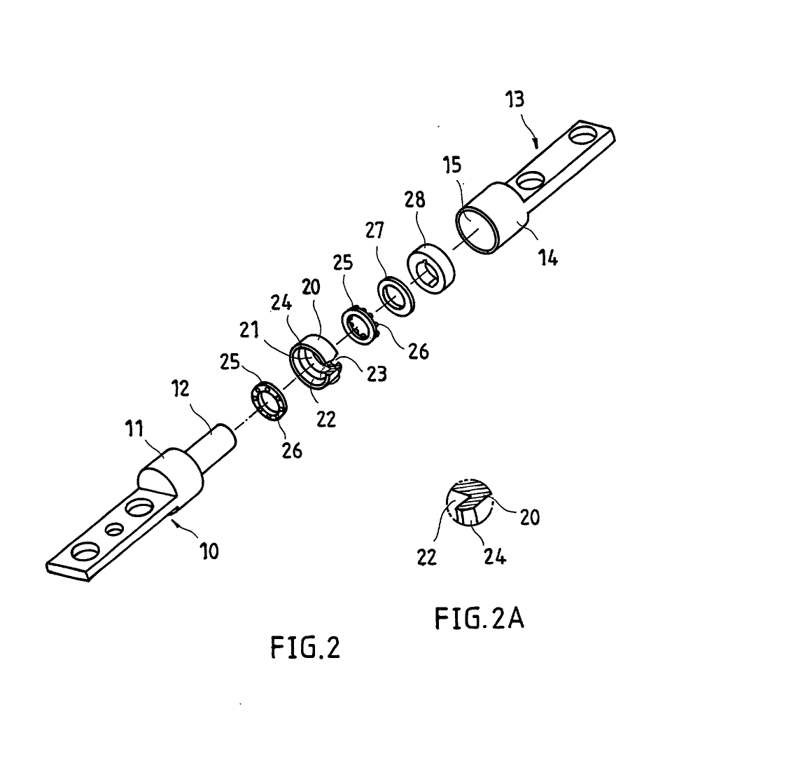

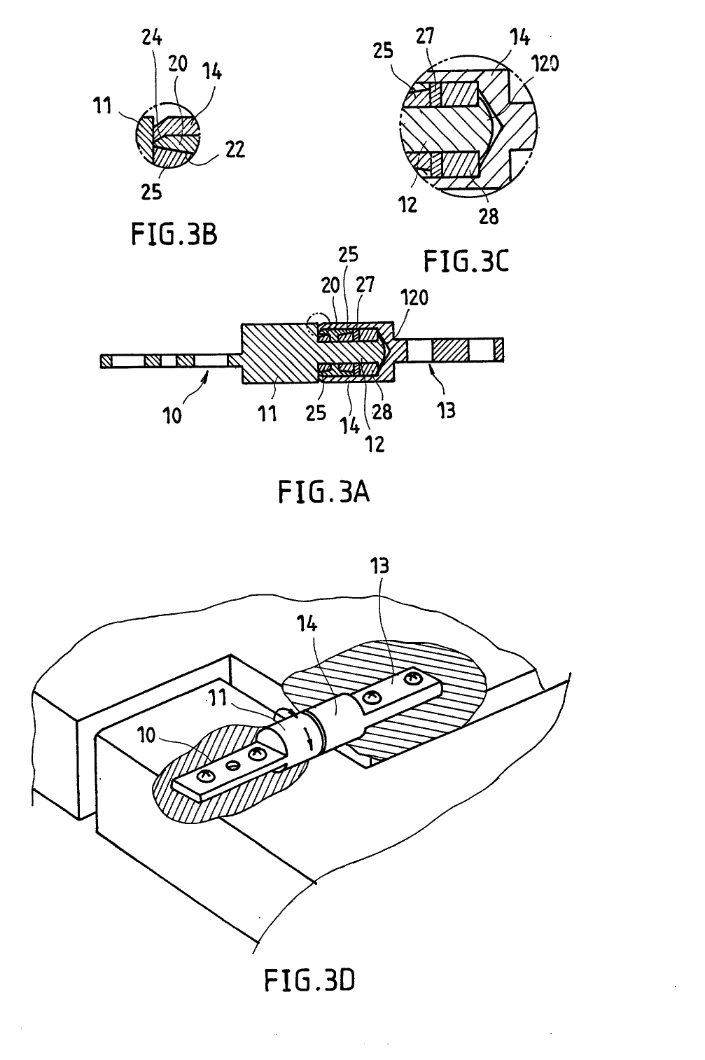

### DETAILED DESCRIPTION OF THE PREFERRED EMBODIMENT

Referring to FIGS. from 2A through 4B, a hinge in accordance with the present invention is generally comprised of a shaft member 10 and a pivot holder 13. The shaft member 10 comprises a shaft head 11 at its one end and a pivot rod 12 axially forwardly extended from the pivot rod 12. The pivot holder 13 comprises a socket 14 forwardly disposed at its one end. The socket 15 defines an axle hole 15. A bushing 20 is mounted on the pivot rod 12 of the shaft member 10, having an outer diameter fitting the diameter of the axle hole 15 of the socket 14 of the pivot holder 13. The bushing 20 comprises a center axle hole 21 fitting the outer diameter of the pivot rod 12 of the shaft member 10, two tapered chambers 22 and 23 axially aligned at two ends of the center axle hole 21, and a sloping peripheral edge 24 disposed at one side thereof around one tapered chamber 22. Two rubber rings 25 are respectively mounted in the tapered chambers 22 and 23 of the bushing 20 and peripherally partially extended out of the bushing 20. The rubber rings 25 each have raised portions 26 over the periphery. A metal reinforcing ring 28 is mounted on the pivot rod 12 of the shaft member 10 and disposed at one side of the bushing 20 remote from the shaft head 11 of the shaft member 10. A copper ring 27 is mounted on the pivot rod 12 of the shaft member 10 and supported between one rubber ring 25 in one tapered chamber 23 of the bushing 20 and the metal reinforcing ring 28. After mounting of the bushing 20, the rubber rings 25, the copper ring 27 and the metal reinforcing ring 28 on the pivot shaft 12 of the shaft member 10, the end of the pivot rod 12 is hammered down to form a pivot head 120, which is stopped at one end of the metal reinforcing ring 28 against the shaft head 11 of the shaft member 10. After formation of the pivot head 120, the rubber rings 25 are deformed. The pivot rod 12 of the shaft member 10 is then inserted with the bushing 20, the rubber rings 25, the copper ring 27 and the metal reinforcing ring 28 into the axle hole 15 of the socket 14 of the pivot holder 13, and then the front peripheral edge of the socket 14 is hammered down and forced into engagement with the sloping peripheral edge 24 of the bushing 20. When assembled, the bushing 20 is coupled to the socket 14 of the pivot holder 13, and prohibited from rotary motion relative to the pivot holder 13.

Referring to FIGS. from 3A through 3D and 4 again, when in use, the shaft member 10 and the pivot holder 13 are respectively fixedly fastened to the two movable parts of a computer apparatus, for example, the mainframe and LCD module (cover panel with module) of a notebook computer.

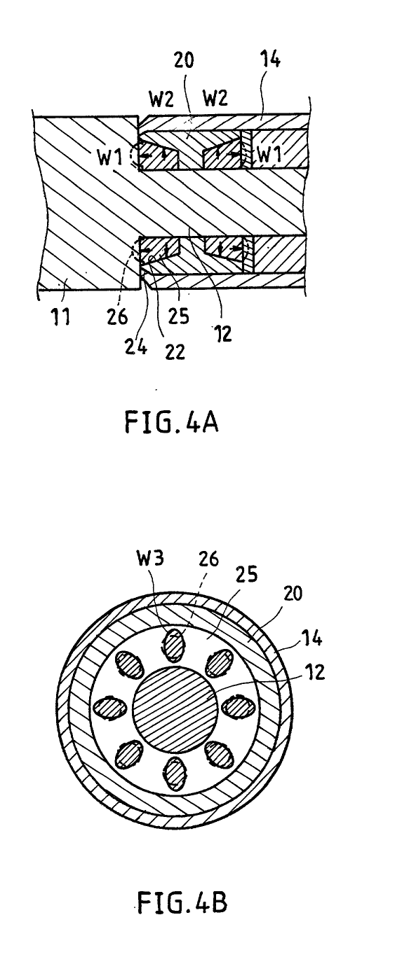

Referring to FIGS. 4A and 4B, the rubber rings 25 are respectively engaged into the tapered chambers 22 and 23 of the bushing 20. After formation of the pivot head 120, the metal reinforcing ring 28 gives a pressure through the copper ring 27 to the rubber rings 25 against the shaft member 10, thereby causing the surface W3 of the raised portions 26 of the rubber rings 25 to be forced against one side of the shaft head 11 of the shaft member 10 to achieve the effects outlined hereinafter. Because the rubber rings 25 are springy, they impart a sideway pressure W2 and a vertical pressure W1 to the shaft member 10 to stop the shaft member 10 from rotary motion relative to the pivot holder 13. Because the rubber rings 25 have raised portions 26 over the surface thereof, the outside wall of each rubber ring 25 is a coarse surface, which produces much friction resistance when squeezed. As indicated, after formation of the pivot head 120 of the pivot rod 12, the deformed rubber rings 25 impart much pressure to the shaft member 10 to stop the shaft member 10 from rotary motion relative to the pivot holder 13. Therefore, the shaft member 10 can be rotated relative to the pivot holder 13 only when the user employs much force to one movable part against the other of the computer apparatus in which the hinge is installed.

As indicated above, the end of the pivot rod 12 is hammered down to form a pivot head 12 to secure the metal reinforcing ring 28, the copper ring 27, the rubber rings 25 and the bushing 20 to the shaft member 10, and the pivot rod 12 with the metal reinforcing ring 28, the copper ring 27, the rubber rings 25 and the bushing 20 are inserted into the axial hole 15 of the socket 14 of the pivot holder 13. Therefore, all the component parts mounting on the pivot rod 12 of the shaft member 10 are received in the socket 14 of the pivot holder 13 and well protected against external substances (moisture, water, oil). Because the chambers 22 and 23 are tapered chambers each having a diameter gradually smaller toward the inside of the bushing 20, the rubber rings 25 are positively secured to the bushing 20 after their insertion into the tapered chambers 22 and 23. Further, because the copper ring 27 is supported on the pivot rod 12 of the shaft member 10 between the metal reinforcing ring 28 and one rubber ring 25, it enables the shaft member 10 to be rotated by force relative to the pivot holder 13 without causing a dead locking. According to the present invention, a torsional force (friction resistance) of about 8 kgs/cm is produced when measured by a torsion meter obtained from “Tohnichi” in case the diameter is 5.0 mm, i.e., sufficient to support an object of moment of force about 30˜35 cm and weight about 3˜4 kgs.

Because the front peripheral edge of the socket 14 is hammered down and secured to the sloping peripheral edge 24 of the bushing 20 and the end of the pivot rod 12 is hammered down to form the pivot head 120 to stop the bushing 20, the rubber rings 25, the copper ring 27 and the metal reinforcing ring 28 in place, the parts of the hinge are prohibited from falling out. According to test, the service life of the hinge is satisfactorily long (sufficient to support more than twenty thousand times of rotation). Because the diameter of the shaft member 10 and the diameter of the pivot holder 13 are small, the hinge requires less installation space. Because no spring element is used, the present invention eliminates the problem of elastic fatigue.

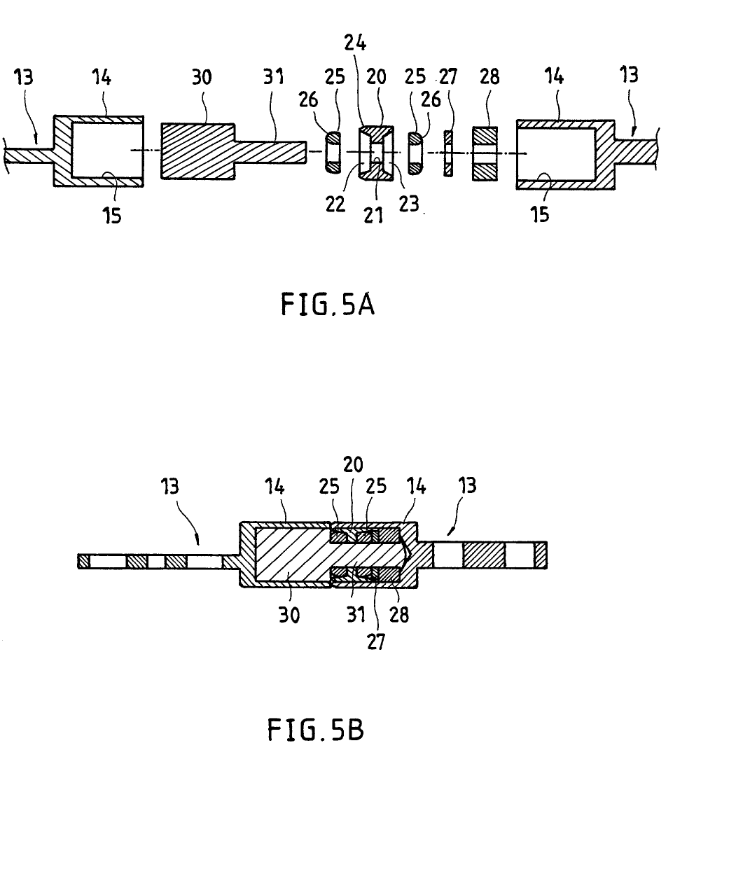

FIGS. 5A and 5B show an alternate form of the present invention. According to this alternate form, the hinge comprises two pivot holders 13, a shaft member 30, a bushing 20, two rubber rings 25, a copper ring 27, and a metal reinforcing ring 28. Except the shaft member 30, the other component parts of the hinge are same as the corresponding component parts of the aforesaid first embodiment of the present invention. The shaft member 30 is inserted into the axial hole 15 of the socket 14 of one pivot holder 13, having a pivot rod 31 axially extended from one end thereof, which has the end hammered down to hold the bushing 20, the rubber rings 25, the copper ring 27 and the metal reinforcing ring 28 in place.

It is to be understood that the drawings are designed for purposes of illustration only, and are not intended for use as a definition of the limits and scope of the invention disclosed. For example, the raised portions 26 of the springy rubber rings 25 can have any of a variety of shapes; alternatively, the springy rubber ring 25 can be made without the aforesaid raised portions 26; the bushing 20 can be made having a groove at each of the two distal ends thereof for receiving the respective rubber rings 25 instead of the aforesaid tapered chambers 22 and 23; the socket 14 can be fastened to the bushing 20 by welding or metal adhesive means.

What the invention claimed is:

1. A hinge fastened to two movable parts of a computer apparatus for enabling said movable parts to be turned relative to each other, the hinge comprising:
a pivot holder fixedly fastened to a first movable part of the computer apparatus, said pivot holder comprising a socket at one end thereof,
a shaft member fastened to a second movable part of the computer apparatus, said shaft member comprising a shaft head at one end thereof and a pivot rod axially forwardly extended from said shaft head, said pivot rod having a distal end terminating in a pivot head;
a bushing mounted on the pivot rod of said shaft member between the pivot head of said pivot rod and the shaft head of said shaft member and fitted into and fixedly fastened to the socket of said pivot holder, said bushing comprising two chambers at two sides thereof and an axial center through hole connected betweens aid two chambers for the passing of said pivot rod of said shaft member;
two springy rubber rings respectively mounted in the chambers of said bushing inside said socket of said pivot holder and squeezed against the shaft head of said shaft member to stop said shaft member from rotary motion relative to said pivot holder; and
a metal reinforcing ring mounted on the pivot rod of said shaft member inside the socket of said pivot holder and stopped between the pivot head of said pivot rod and one rubber ring in one chamber of said bushing.

2. The hinge of claim 1 wherein said springy rubber ring has raised portions over the surface thereof.

3. The hinge of claim 1 wherein said chambers of said bushing are tapered chambers each having a diameter gradually smaller toward the inside of said bushing.

4. The hinge of claim 1 further comprising a copper ring mounted on the pivot rod of said shaft member and supported between said metal reinforcing ring and one rubber ring in one chamber of said bushing inside the socket of said pivot holder.

5. The hinge of claim 1 wherein said bushing has a sloping peripheral edge at one side thereof, and the socket of said pivot holder has a peripheral edge riveted to the sloping peripheral edge of said bushing.

6. The hinge of claim 1 wherein the socket of said pivot holder is welded to said bushing.

7. The hinge of claim 1 wherein the socket of said pivot holder is adhered to said bushing.

8. The hinge of claim 1 wherein said pivot head of said pivot rod is a nut threaded onto an outer thread at the distal end of said pivot rod.

9. A hinge fastened to two movable parts of a computer apparatus for enabling said movable parts to be turned relative to each other, the hinge comprising:
a first pivot holder and a second pivot holder respectively fixedly fastened to the two movable parts of the computer apparatus, said first and second pivot holders each comprising a socket at one end;
a shaft member, said shaft member comprising a shaft body press-fitted into the socket of said first pivot holder, and a pivot rod axially forwardly disposed outside said first pivot holder, said pivot rod having a distal end terminating in a pivot head;
a bushing mounted on the pivot rod of said shaft member between the pivot head of said pivot rod and the shaft body of said shaft member and fitted into and fixedly fastened to the socket of said second pivot holder, said bushing comprising two chambers at two sides thereof and an axial center through hole connected betweens aid two chambers for the passing of said pivot rod of said shaft member;
two springy rubber rings respectively mounted in the chambers of said bushing inside said socket of said second pivot holder and squeezed against the shaft body of said shaft member to stop said first pivot holder and said shaft member from rotary motion relative to said second pivot holder;
a metal reinforcing ring mounted on the pivot rod of said shaft member inside the socket of said second pivot holder and stopped between the pivot head of said pivot rod and one rubber ring in one chamber of said bushing; and
a copper ring mounted on the pivot rod of said shaft member and supported between said metal reinforcing ring and one rubber ring in one chamber of said bushing inside the socket of said second pivot holder.
